(19) United States
(12) Patent Application Publication
(10) Pub. No.: US 2023/0345534 A1
(43) Pub. Date: Oct. 26, 2023

(54) Transmission Protection With Static Puncturing In Wireless Communications

(71) Applicant: MediaTek Inc., Hsinchu City (TW)

(72) Inventors: Kai Ying Lu, San Jose, CA (US); James Chih-Shi Yee, San Jose, CA (US); Yongho Seok, San Jose, CA (US)

(21) Appl. No.: 18/137,403

(22) Filed: Apr. 20, 2023

Related U.S. Application Data
(60) Provisional application No. 63/333,591, filed on Apr. 22, 2022.

(51) Int. Cl. H04W 74/08; H04W 72/0457

(52) U.S. Cl. CPC H04W 74/0816; H04W 72/0457

(57) ABSTRACT

Techniques pertaining to transmission protection with static puncturing in wireless communications are described. An apparatus (e.g., a station (STA)) receives a control frame with bandwidth signaling that is transmitted in a channel width of the control frame including one or more non-punctured non-primary subchannels within the channel width. The apparatus then determines the one or more non-punctured non-primary subchannels within the channel width of the control frame and also determines whether to transmit a response control frame responsive to receiving the control frame. Depending on a result of the determining, the apparatus either refrains from transmission of the response control frame or transmits the response control frame in at least one subchannel within the channel width of the control frame.

### CROSS REFERENCE TO RELATED PATENT APPLICATION

The present disclosure is part of a non-provisional patent application claiming the priority benefit of U.S. Provisional Patent Application No. 63/333,591, filed Apr. 22, 2022, the content of which herein being incorporated by reference in its entirety.

### TECHNICAL FIELD

The present disclosure is generally related to wireless communications and, more particularly, to transmission protection with static puncturing in wireless communications.

### BACKGROUND

Unless otherwise indicated herein, approaches described in this section are not prior art to the claims listed below and are not admitted as prior art by inclusion in this section.

In wireless communication, such as Wi-Fi as specified in accordance with one or more Institute of Electrical and Electronics Engineers (IEEE) 802.11 specification, static and dynamic bandwidth indication may be utilized in request-to-send (RTS) and clear-to-send (CTS) procedures. However, how to provide transmission protection in extremely-high-throughput (EHT) RTS and CTS procedures to avoid collisions and improve overall system performance remains an issue and needs to be defined. Therefore, there is a need for a solution of transmission protection with static puncturing in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to transmission protection with static puncturing in wireless communications. It is believed that aforementioned issue(s) may be avoided or otherwise alleviated by implementation of one or more of various proposed schemes described herein.

In one aspect, a method may involve a processor of an apparatus (e.g., as a station (STA) as a transmit opportunity (TXOP) responder) receiving a control frame with bandwidth signaling that is transmitted in a channel width of the control frame including one or more non-punctured non-primary subchannels within the channel width. The method may also involve the processor determining the one or more non-punctured non-primary subchannels within the channel width of the control frame as well as determining whether to transmit a response control frame responsive to receiving the control frame. Depending on a result of the determining, the method may involve the processor performing different operations. For instance, the method may involve the processor refraining from transmission of the response control frame. Alternatively, the method may involve the processor transmitting the response control frame in at least one subchannel within the channel width of the control frame.

In another aspect, a method may involve a processor of an apparatus (e.g., as a STA as a TXOP initiator) transmitting a control frame with bandwidth signaling that is transmitted in a channel width of the control frame including one or more non-punctured non-primary subchannels within the channel width. In response to transmitting the control frame, the method may involve the processor receiving no response control frame. Alternatively, the method may involve the processor receiving a response control frame in at least one subchannel within the channel width of the control frame.

In yet another aspect, an apparatus may include a transceiver configured to communicate wirelessly and a processor coupled to the transceiver. The processor may receive a control frame with bandwidth signaling that is transmitted in a channel width of the control frame including one or more non-punctured non-primary subchannels within the channel width. The processor may determine the one or more non-punctured non-primary subchannels within the channel width of the control frame as well as determine whether to transmit a response control frame responsive to receiving the control frame. Depending on a result of the determining, the processor may perform different operations. For instance, the processor may refrain from transmission of the response control frame. Alternatively, the processor may transmit the response control frame in at least one subchannel within the channel width of the control frame.

In still another aspect, an apparatus may include a transceiver configured to communicate wirelessly and a processor coupled to the transceiver. The processor may transmit a control frame with bandwidth signaling that is transmitted in a channel width of the control frame including one or more non-punctured non-primary subchannels within the channel width. In response to transmitting the control frame, the processor may receive no response control frame. Alternatively, the processor may receive a response control frame in at least one subchannel within the channel width of the control frame.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies such as, for example and without limitation, Bluetooth, ZigBee, 5th Generation (5G)/New Radio (NR), Long-Term Evolution (LTE), LTE-Advanced, LTE-Advanced Pro, Internet-of-Things (IoT), Industrial loT (IoT) and narrowband loT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example design under a proposed scheme in accordance with the present disclosure.

FIG. 6 is a diagram of an example scenario under a proposed scheme in accordance with the present disclosure.

FIG. 7 is a block diagram of an example communication system in accordance with an implementation of the present disclosure.

FIG. 8 is a flowchart of an example process in accordance with an implementation of the present disclosure.

FIG. 9 is a flowchart of another example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

Overview

Implementations in accordance with the present disclosure relate to various techniques, methods, schemes and/or solutions pertaining to transmission protection with static puncturing in wireless communications. According to the present disclosure, a number of possible solutions may be implemented separately or jointly. That is, although these possible solutions may be described below separately, two or more of these possible solutions may be implemented in one combination or another.

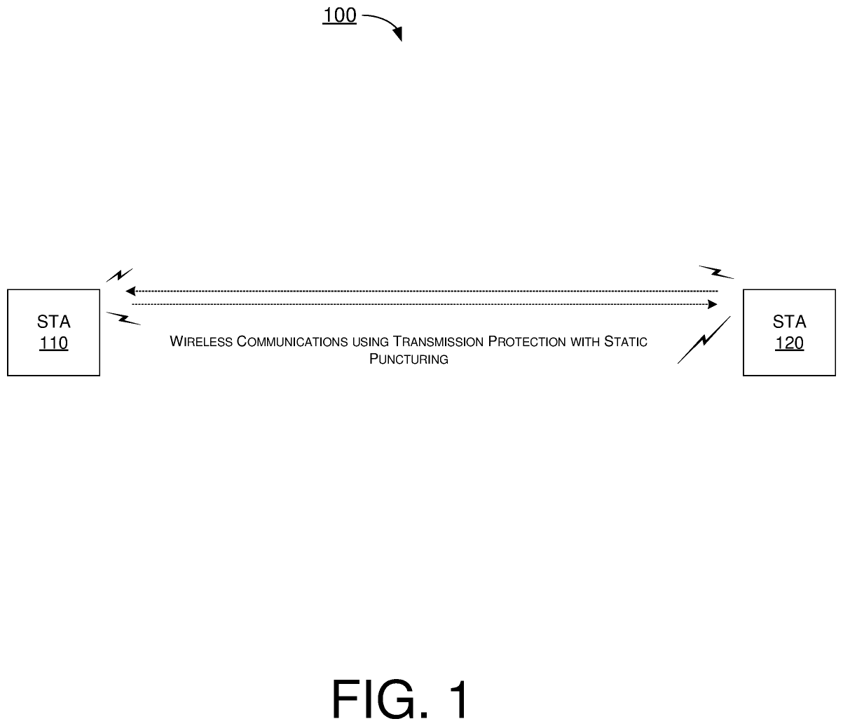

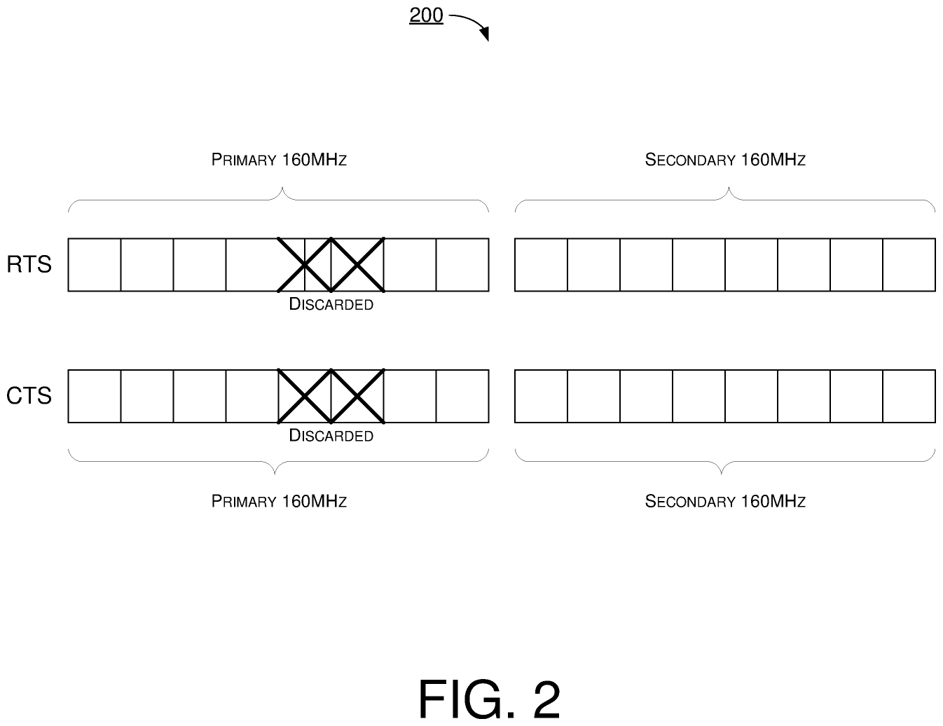

FIG. 1 illustrates an example network environment 100 in which various solutions and schemes in accordance with the present disclosure may be implemented. FIG. 2-FIG. 9 illustrate examples of implementation of various proposed schemes in network environment 100 in accordance with the present disclosure. The following description of various proposed schemes is provided with reference to FIG. 1-FIG. 9.

Referring to FIG. 1, network environment 100 may involve at least a STA 110 communicating wirelessly with a STA 120. Each of STA 110 and STA 120 may be a non-access point (non-AP) STA or, alternatively, either of STA 110 and STA 120 may function as an access point (AP) STA. In some cases, STA 110 and STA 120 may be associated with a basic service set (BSS) in accordance with one or more IEEE 802.11 standards (e.g., IEEE 802.11 be and future-developed standards). Each of STA 110 and STA 120 may be configured to communicate with each other by utilizing the techniques pertaining to transmission protection with static puncturing in wireless communications in accordance with various proposed schemes described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

With respect to static and dynamic bandwidth indication in RTS and CTS procedures, a very-high-throughput (VHT) STA that is addressed by an RTS frame in a non-high-throughput (non-HT) or non-HT duplicate physical-layer protocol data unit (PPDU) that has a bandwidth signaling transmitter address (TA) and that has the RXVECTOR parameter DYN_BANDWIDTH_IN_NON_HT equal to Static behaves in a certain way, as described below. In case that the network allocation vector (NAV) indicates idle and clear channel assessment (CCA) has been idle for all secondary channels (e.g., secondary 20 MHz channel, secondary 40 MHz channel, and secondary 80 MHz channel) in the channel width indicated by the RTS frame's RXVECTOR parameter CH BANDWIDTH IN NON HT for a point coordination function (PCF) inter-frame spacing (PIFS) prior to the start of the RTS frame, then the STA may respond with a CTS frame carried in a non-HT or non-HT duplicate PPDU after a short inter-frame spacing (SIFS). The CTS frame's TXVECTOR parameters CH_BANDWIDTH and CH_BANDWIDTH_IN_NON_HT may be set to the same value as the RTS frame's RXVECTOR parameter CH_BANDWIDTH_IN_NON_HT. Otherwise, the STA may not respond with a CTS frame.

On the other hand, a VHT STA that is addressed by an RTS frame in a non-HT or non-HT duplicate PPDU that has a bandwidth signaling TA and that has the RXVECTOR parameter DYN_BANDWIDTH_IN_NON_HT equal to Dynamic behaves in a certain way, as described below. In case that the NAV indicates idle, the STA may respond with a CTS frame in a non-HT or non-HT duplicate PPDU after a SIFS. The CTS frame's TXVECTOR parameters CH_BANDWIDTH and CH_BANDWIDTH_IN_NON_HT may be set to any channel width for which CCA on all secondary channels has been idle for a PIFS prior to the start of the RTS frame and that is less than or equal to the channel width indicated in the RTS frame's RXVECTOR parameter CH_BANDWIDTH_IN_NON_HT. Otherwise, the STA shall not respond with a CTS frame.

Moreover, with respect to static and dynamic bandwidth indication in RTS and CTS procedures, the same scrambler may be used to scramble transmit data and to descramble receive data. In case that the TXVECTOR parameter CH_BANDWIDTH_IN_NON_HT is not present, when transmitting, the initial state of the scrambler may be set to a pseudorandom nonzero state. However, in case that the TXVECTOR parameter CH_BANDWIDTH_IN_NON_HT is present, certain operations may be undertaken. Firstly, the first 7 bits of the scrambling sequence may be set and may be also used to initialize the state of the scrambler. Secondly, the scrambler with this initialization may generate the remainder (e.g., after the first 7 bits) of the scrambling sequence. Thirdly, the TXVECTOR parameter CH_BANDWIDTH_IN_NON_HT may be transmitted with its least-significant bit (LSB) first. For example, if channel bandwidth of 80 MHz (CBW80) has a value of 2, which is 10 in binary representation, then B5=0 and B6=1.

With respect to preamble puncturing of PPDUs for transmission, four modes of puncturing are feasible. A first mode (Mode 1), for transmission in a 80 MHz operating bandwidth, involves puncturing a secondary 20 MHz channel (S20) in a primary 40 MHz channel of two 40 MHz channels of the 80 MHz operating bandwidth. A second mode (Mode 2), for transmission in the 80 MHz operating bandwidth, involves puncturing either a left 20 MHz channel (S40-L) or a right 20 MHz channel (S40-R) of a secondary 40 MHz channel of two 40 MHz channels of the 80 MHz operating bandwidth. A third mode (Mode 3), for transmission in a 160 MHz operating bandwidth, involves puncturing a secondary 20 MHz channel (S20) in a primary 40 MHz channel of two 40 MHz channels of a primary 80 MHz channel of two 80 MHz channels of the 160 MHz operating bandwidth. A fourth mode (Mode 4), for transmission in a 160 MHz operating bandwidth, involves puncturing at least one 20 MHz channel (S40-L or S40-R or both S40-L and S40-R) of a secondary 40 MHz channel of two 40 MHz channels of the primary 80 MHz channel of two 80 MHz channels of the 160 MHz operating bandwidth. It is noteworthy that, in Mode 3 and Mode 4, one, two or three 20 MHz channels of a secondary 80 MHz channel (S80) of the two 80 MHz channels of the 160 MHz operating bandwidth may also be punctured.

Under a proposed scheme in accordance with the present disclosure with respect to EHT RTS and CTS procedures with static preamble puncturing, a transmit opportunity (TXOP) initiator may transmit to a TXOP responder an RTS frame in a non-HT (duplicate) PPDU with the following TXVECTOR parameters: (1) CH_BANDWIDTH_IN_NON_HT, indicating the channel bandwidth as being 20 MHz (CBW20), 40 MHz (CBW40), 80 MHz (CBW80), 160 MHz (CBW160) or 320 MHz (CBW320); and (2) INACTIVE_SUBCHANNELS, indicating one or more 20 MHz subchannels that are punctured, if present. Under the proposed scheme, the TXOP initiator transmitting the RTS frame may set the TXVECTOR parameter INACTIVE_SUBCHANNELS of the non-HT duplicate PPDU based on the value indicated in the most-recently exchanged Disabled Subchannel Bitmap field in an EHT Operation element for that BSS, which may be carried in beacon frame(s) and/or some other management frame(s) transmitted by an AP. Moreover, the RTS frame may be transmitted on a bandwidth indicated in the TXVECTOR parameter CH_BANDWIDTH _IN_NON_HT without using any 20 MHz subchannels indicated as disabled (meaning punctured) in the Disabled Subchannel Bitmap field in the EHT Operation element for that BSS.

Under the proposed scheme, the TXOP responder may transmit to the TXOP initiator a CTS frame in a non-HT (duplicate) PPDU based on the following TXVECTOR parameters: (1) CH_BANDWIDTH_IN_NON_HT, indicating the channel bandwidth as being CBW20, CBW40, CBW80, CBW160 or CBW320; and (2) INACTIVE_SUBCHANNELS, indicating one or more 20 MHz subchannels that are punctured, if present. Additionally, the TXOP responder transmitting the CTS frame may set the TXVECTOR parameter INACTIVE_SUBCHANNELS of the non-HT duplicate PPDU based on the value indicated in the most-recently exchanged Disabled Subchannel Bitmap field in the EHT Operation element for that BSS. Furthermore, the CTS frame may be transmitted on a bandwidth based on the RTS frame's RXVECTOR parameter CH_BANDWIDTH_IN_NON_HT without using any 20 MHz subchannels indicated as disabled (or punctured) in the Disabled Subchannel Bitmap field in the EHT Operation element for that BSS.

Under a proposed scheme in accordance with the present disclosure with respect to a CTS procedure with static preamble puncturing, a STA that is addressed by an RTS frame in a non-HT or non-HT duplicate PPDU that has a bandwidth signaling TA and that has the RXVECTOR parameter DYN_BANDWIDT_IN_NON_HT equal to Static may behave in a certain way for static bandwidth negotiation with static preamble puncturing, as described below. In case that the NAV indicates idle (meaning virtual channel sensing is idle), the STA is not non-simultaneous-transmission-and-reception (NSTR) limited and CCA has been idle for all secondary channels (e.g., secondary 20 MHz channel, secondary 40 MHz channel, secondary 80 MHz channel and secondary 160 MHz channel) in the channel width indicated by the RTS frame's RXVECTOR parameter CH_BANDWIDTH_IN_NON_HT, except for any 20 MHz subchannel indicated as a punctured subchannel in the Disabled Subchannel Bitmap field in the EHT Operation element (meaning that only the non-punctured subchannels indicated in the Disabled Subchannel Bitmap field in the EHT Operation element may be considered for CCA idle or busy for the all secondary channels), for a PIFS (e.g., 25 microseconds) prior to the start of the RTS frame, the STA may respond with a CTS frame carried in a non-HT or non-HT duplicate PPDU after a SIFS. The CTS frame's TXVECTOR parameters CH_BANDWIDTH and CH_BANDWIDTH_IN_NON_HT may be set to the same value as the RTS frame's RXVECTOR parameter CH_BANDWIDTH_IN_NON_HT. Otherwise, the STA may not respond with a CTS frame.

Under a proposed scheme in accordance with the present disclosure with respect to a CTS procedure with static preamble puncturing, a STA that is addressed by an RTS frame in a non-HT or non-HT duplicate PPDU that has a bandwidth signaling TA and that has the RXVECTOR parameter DYN_BANDWIDTH_IN_NON_HT equal to Dynamic may behave in a certain way for dynamic bandwidth negotiation with static preamble puncturing, as described below. In case that the NAV indicates idle, and the STA is not NSTR limited, then the STA may respond with a CTS frame in a non-HT or non-HT duplicate PPDU after a SIFS. The CTS frame's TXVECTOR parameters CH_BANDWIDTH and CH_BANDWIDTH_IN_NON_HT may be set to any channel width for which CCA on all secondary channels within the channel width has been idle, except for any 20 MHz subchannel indicated as a punctured subchannel in the Disabled Subchannel Bitmap field in the EHT Operation element (meaning that only the non-punctured subchannels indicated in the Disabled Subchannel Bitmap field in the EHT Operation element may be considered for CCA idle or busy for the secondary channels), for a PIFS prior to the start of the RTS frame and that is less than or equal to the channel width indicated in the RTS frame's RXVECTOR parameter CH_BANDWIDTH_IN_NON_HT. Otherwise, the STA may not respond with a CTS frame.

FIG. 2 illustrates an example scenario 200 of RTS and CTS procedures with static preamble puncturing under a proposed scheme in accordance with the present disclosure. In scenario 200, an RTS frame may be transmitted by a TXOP initiator in a 320 MHz bandwidth with two 20 MHz subchannels indicated as disabled (or punctured) in the Disabled Subchannel Bitmap field in the EHT Operation element for that BSS. The RTS frame may indicate Static bandwidth negotiation with DYN_BANDWIDTH_IN_NON_HT equal to Static. The CTS frame, as the response of the RTS frame, may be transmitted in the 320 MHz bandwidth without two 20 MHz subchannels indicated as disabled (or punctured) in the Disabled Subchannel Bitmap field in the EHT Operation element for that BSS, if all secondary channels are CCA idle except for the disabled/punctured subchannels. In this example, only the non-punctured subchannels indicated in the Disabled Subchannel Bitmap field in the EHT Operation element may be considered for CCA idle or busy.

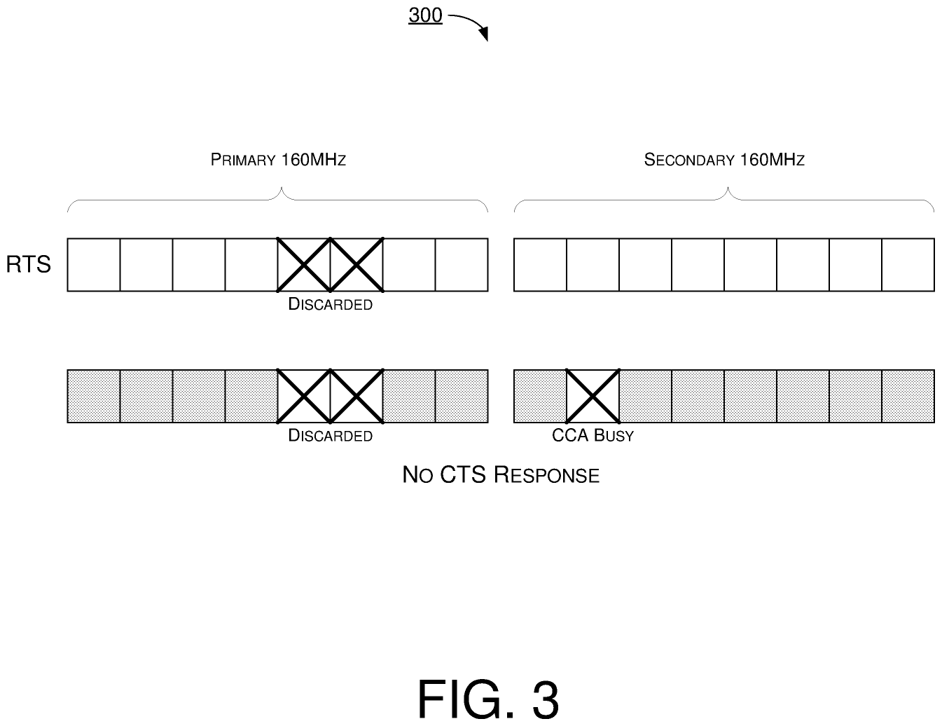

FIG. 3 illustrates an example scenario 300 of RTS and CTS procedures with static preamble puncturing under a proposed scheme in accordance with the present disclosure. In scenario 300, an RTS frame may be transmitted by a TXOP initiator in a 320 MHz bandwidth with two 20 MHz subchannels indicated as disabled (or punctured) in the Disabled Subchannel Bitmap field in the EHT Operation element for that BSS. The RTS frame may indicate Static bandwidth negotiation with DYN_BANDWIDTH_IN_NON_HT equal to Static. In scenario 300, the CCA on a 20 MHz subchannel in the secondary 160 MHz may be non-idle. The CTS frame may not be transmitted if any subchannel within the 320 MHz bandwidth of the RTS frame is CCA busy, except for two 20 MHz subchannels indicated as disabled (or punctured) in the Disabled Subchannel Bitmap field in the EHT Operation element for that BSS. In this example, only the non-punctured subchannels indicated in the Disabled Subchannel Bitmap field in the EHT Operation element may be considered for CCA idle or busy.

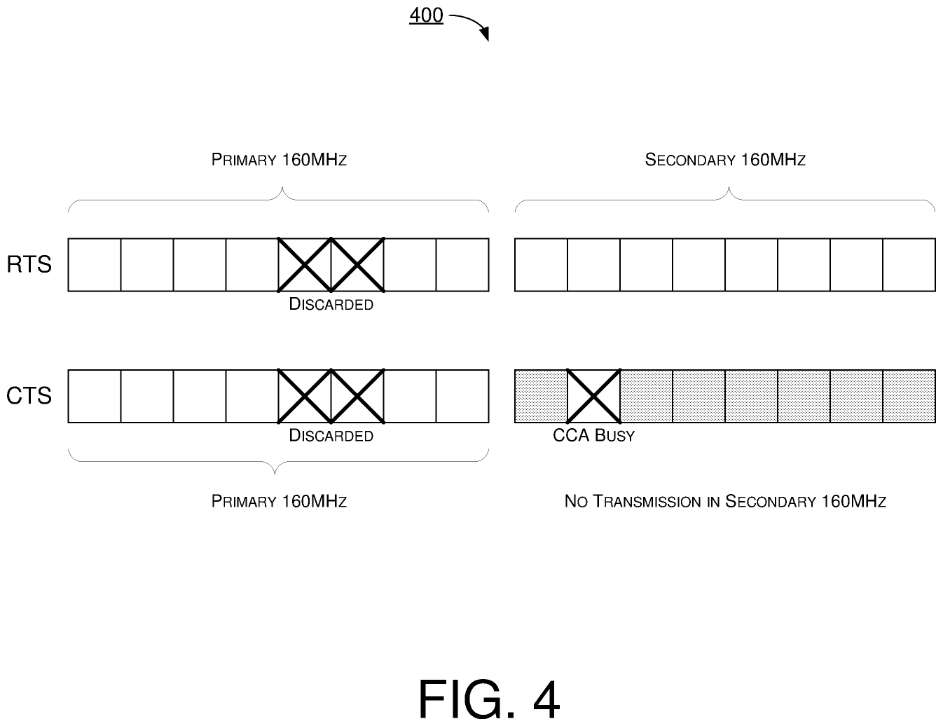

FIG. 4 illustrates an example scenario 400 of RTS and CTS procedures with static preamble puncturing under a proposed scheme in accordance with the present disclosure. In scenario 400, an RTS frame may be transmitted by a TXOP initiator in a 320 MHz bandwidth with two 20 MHz subchannels indicated as disabled (or punctured) in the Disabled Subchannel Bitmap field in the EHT Operation element for that BSS. The RTS frame may indicate Static bandwidth with DYN_BANDWIDTH_IN_NON_HT equal to Dynamic. In scenario 400, the CCA on a 20 MHz subchannel in the secondary 160 MHz may be non-idle. The CTS frame, as the response of the RTS frame, may only be transmitted in a primary 160 MHz bandwidth with two 20 MHz subchannels indicated as disabled (or punctured) in the Disabled Subchannel Bitmap field in the EHT Operation element for that BSS. This means that only the non-punctured subchannels indicated in the Disabled Subchannel Bitmap field in the EHT Operation element may be considered for CCA idle or busy.

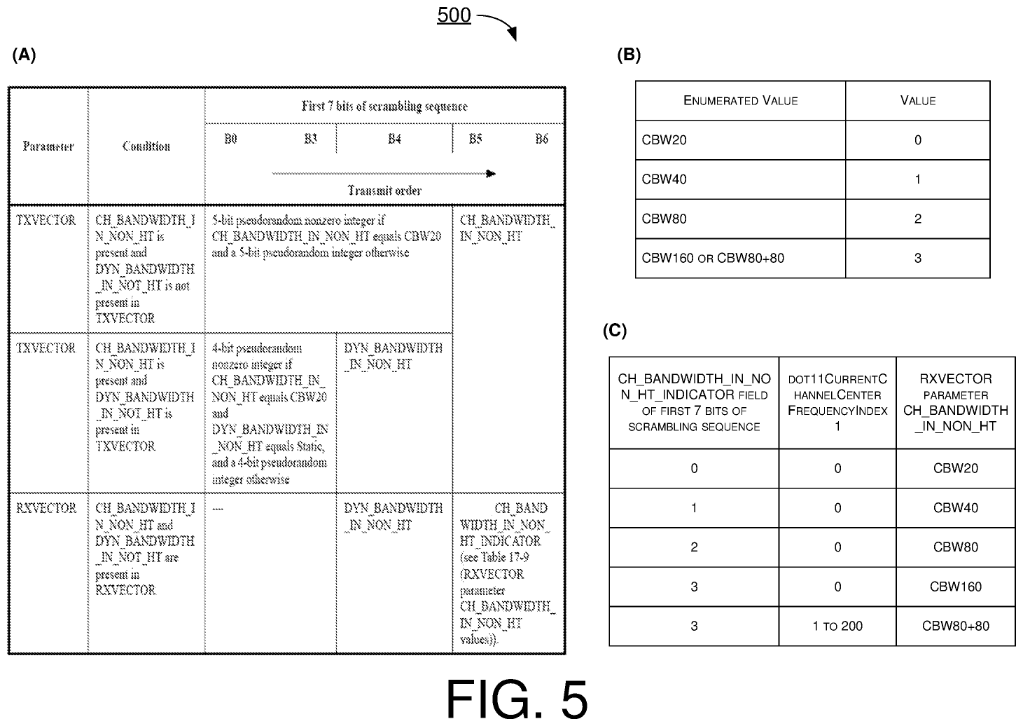

FIG. 5 illustrates an example design 500 for static and dynamic bandwidth indication in RTS and CTS procedures under a proposed scheme in accordance with the present disclosure. Part (A) of FIG. 5 shows an example of the contents of first 7 bits of a scrambling sequence. Part (B) of FIG. 5 shows an example of TXVECTOR parameter CH_BANDWIDTH_IN_NON_HT values. Part (C) of FIG. 5 shows an example of RXVECTOR parameter CH BANDWIDTH IN NON HT values.

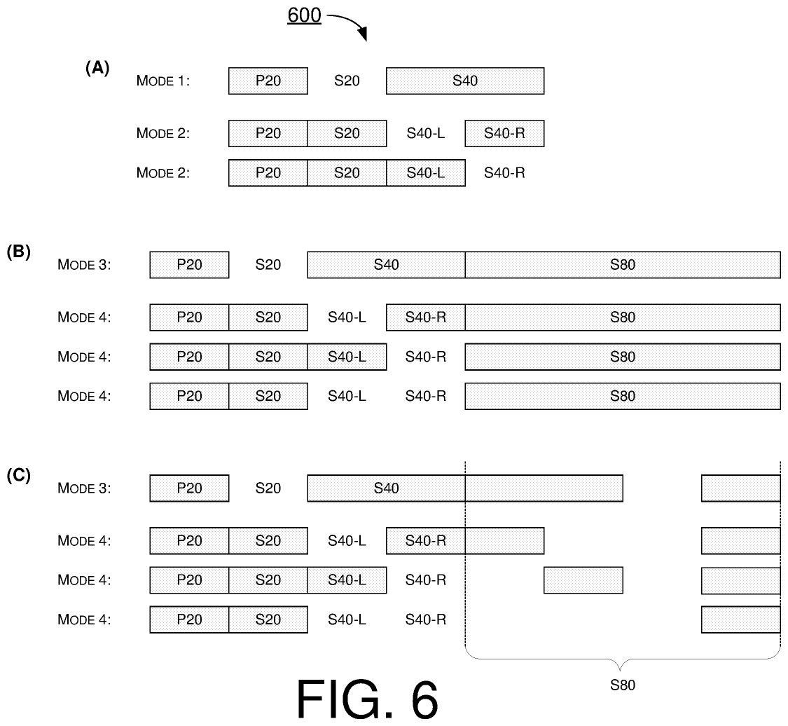

FIG. 6 illustrates an example scenario 600 of preamble puncturing of PPDUs under a proposed scheme in accordance with the present disclosure. Part (A) of FIG. 6 shows an example of Mode 1 and Mode 2 of preamble puncturing for an 80 MHz operating bandwidth. Part (B) of FIG. 6 shows an example of Mode 3 and Mode 4 of preamble puncturing for a 160 MHz operating bandwidth. Part (C) of FIG. 6 shows another example of Mode 3 and Mode 4 of preamble puncturing for a 160 MHz operating bandwidth. In each part of FIG. 6, the shaded portions indicate non-punctured channels/subchannels, and non-shaded (or white) portions indicate punctured channels/subchannels.

Illustrative Implementations

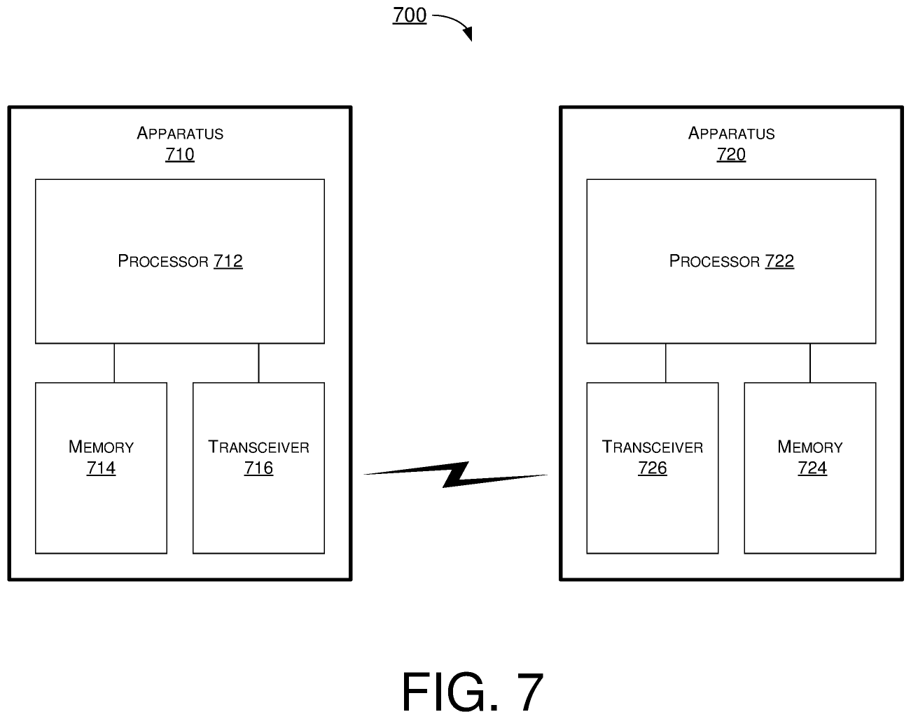

FIG. 7 illustrates an example system 700 having at least an example apparatus 710 and an example apparatus 720 in accordance with an implementation of the present disclosure. Each of apparatus 710 and apparatus 720 may perform various functions to implement schemes, techniques, processes and methods described herein pertaining to transmission protection with static puncturing in wireless communications, including the various schemes described above with respect to various proposed designs, concepts, schemes, systems and methods described above as well as processes described below. For instance, apparatus 710 may be implemented in STA 110 and apparatus 720 may be implemented in STA 120, or vice versa.

Each of apparatus 710 and apparatus 720 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 710 and apparatus 720 may be implemented in a smartphone, a smart watch, a personal digital assistant, a digital camera, or a computing equipment such as a tablet computer, a laptop computer or a notebook computer. Each of apparatus 710 and apparatus 720 may also be a part of a machine type apparatus, which may be an loT apparatus such as an immobile or a stationary apparatus, a home apparatus, a wire communication apparatus or a computing apparatus. For instance, each of apparatus 710 and apparatus 720 may be implemented in a smart thermostat, a smart fridge, a smart door lock, a wireless speaker or a home control center. When implemented in or as a network apparatus, apparatus 710 and/or apparatus 720 may be implemented in a network node, such as an AP in a WLAN.

In some implementations, each of apparatus 710 and apparatus 720 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 710 and apparatus 720 may be implemented in or as a STA or an AP. Each of apparatus 710 and apparatus 720 may include at least some of those components shown in FIG. 7 such as a processor 712 and a processor 722, respectively, for example. Each of apparatus 710 and apparatus 720 may further include one or more other components not pertinent to the proposed scheme of the present disclosure (e.g., internal power supply, display device and/or user interface device), and, thus, such component(s) of apparatus 710 and apparatus 720 are neither shown in FIG. 7 nor described below in the interest of simplicity and brevity.

In one aspect, each of processor 712 and processor 722 may be implemented in the form of one or more single-core processors, one or more multi-core processors, one or more RISC processors or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks including those pertaining to transmission protection with static puncturing in wireless communications in accordance with various implementations of the present disclosure.

In some implementations, apparatus 710 may also include a transceiver 716 coupled to processor 712. Transceiver 716 may include a transmitter capable of wirelessly transmitting and a receiver capable of wirelessly receiving data. In some implementations, apparatus 720 may also include a transceiver 726 coupled to processor 722. Transceiver 726 may include a transmitter capable of wirelessly transmitting and a receiver capable of wirelessly receiving data. It is noteworthy that, although transceiver 716 and transceiver 726 are illustrated as being external to and separate from processor 712 and processor 722, respectively, in some implementations, transceiver 716 may be an integral part of processor 712 as a system on chip (SoC), and transceiver 726 may be an integral part of processor 722 as a SoC.

In some implementations, apparatus 710 may further include a memory 714 coupled to processor 712 and capable of being accessed by processor 712 and storing data therein. In some implementations, apparatus 720 may further include a memory 724 coupled to processor 722 and capable of being accessed by processor 722 and storing data therein. Each of memory 714 and memory 724 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 714 and memory 724 may include a type of read-only memory (ROM) such as mask ROM, programmable ROM (PROM), erasable programmable ROM (EPROM) and/or electrically erasable programmable ROM (EEPROM). Alternatively, or additionally, each of memory 714 and memory 724 may include a type of non-volatile random-access memory (NVRAM) such as flash memory, solid-state memory, ferroelectric RAM (FeRAM), magnetoresistive RAM (MRAM) and/or phase-change memory.

Each of apparatus 710 and apparatus 720 may be a communication entity capable of communicating with each other using various proposed schemes in accordance with the present disclosure. For illustrative purposes and without limitation, a description of capabilities of apparatus 710, as STA 110, and apparatus 720, as STA 120, is provided below. It is noteworthy that, although a detailed description of capabilities, functionalities and/or technical features of apparatus 720 is provided below, the same may be applied to apparatus 710 although a detailed description thereof is not provided solely in the interest of brevity. It is also noteworthy that, although the example implementations described below are provided in the context of WLAN, the same may be implemented in other types of networks.

Under various proposed schemes pertaining to transmission protection with static puncturing in wireless communications in accordance with the present disclosure, with apparatus 710 implemented in or as STA 110 and apparatus 720 implemented in or as STA 120 in network environment 100, processor 712 of apparatus 710 may receive, via transceiver 716, a control frame (e.g., RTS frame) with bandwidth signaling that is transmitted in a channel width of the control frame including one or more non-punctured non-primary subchannels (e.g., non-primary subchannel(s) being punctured) within the channel width. Moreover, processor 712 may determine the one or more non-punctured non-primary subchannels within the channel width of the control frame as well as determine whether to transmit a response control frame (e.g., CTS frame) responsive to receiving the control frame. Depending on a result of the determining, processor 712 may perform different operations. For instance, processor 712 may refrain from transmission of any response control frame. Alternatively, processor 712 may transmit, via transceiver 716, the response control frame (e.g., to apparatus 720) in at least one subchannel within the channel width of the control frame.

In some implementations, in determining the one or more non-punctured non- primary subchannels within the channel width of the control frame, processor 712 may determine the one or more non-punctured non-primary subchannels within the channel width of the control frame based on a Disabled Subchannel Bitmap field in an EHT Operation element for a BSS with which apparatus 710 is associated indicating punctured subchannels. In some implementations, in determining whether to transmit the response control frame, processor 712 may perform, via transceiver 716, CCA on the one or more non-punctured non-primary subchannels within the channel width of the received control frame to determine whether each of the one or more non-punctured non-primary subchannels is CCA idle or busy.

In some implementations, the control frame may indicate static bandwidth negotiation with a DYN_BANDWIDTH_IN_NON_HT field set to indicate Static. In some implementations, in refraining from transmission of the response control frame, processor 712 may refrain from transmission of the response control frame responsive to at least one of the one or more non-punctured non-primary subchannels being determined to be CCA busy. In some implementations, in transmitting the response control frame, processor 712 may transmit the response control frame in the one or more non-punctured non-primary subchannels within the channel width of the received control frame responsive to each of the one or more non-punctured non-primary subchannels being determined to be CCA idle.

In some implementations, the control frame may indicate static bandwidth negotiation with a DYN_BANDWIDTH_IN_NON_HT field set to indicate Dynamic. In some implementations, in transmitting the response control frame, processor 712 may transmit the response control frame with a second channel width for which all the one or more non-punctured non-primary subchannels are within the second channel width responsive to each of the one or more non-punctured non-primary subchannels being determined to be CCA idle. In such cases, the second channel width may be less than or equal to the channel width of the received control frame. Alternatively, or additionally, in transmitting the response control frame, processor 712 may transmit the response control frame in one or more non-punctured non-primary subchannels in a first channel but not a second channel of the two or more channels responsive to each of the one or more non-punctured non-primary subchannels in the first channel being determined to be CCA idle and at least one subchannel in the second channel being determined to be CCA busy.

In some implementations, the operation bandwidth may be 320 MHz, and the two or more channels may include a primary 160 MHz channel and a secondary 160 MHz channel. Each of the primary 160 MHz channel and the secondary 160 MHz channel may respectively include eight 20 MHz subchannels.

Under various proposed schemes pertaining to transmission protection with static puncturing in wireless communications in accordance with the present disclosure, with apparatus 710 implemented in or as STA 110 and apparatus 720 implemented in or as STA 120 in network environment 100, processor 722 of apparatus 720 may transmit, via transceiver 726, a control frame (e.g., RTS frame) with bandwidth signaling that is transmitted in a channel width of the control frame including one or more non-punctured non-primary subchannels (e.g., non-primary subchannel(s) being punctured) within the channel width. Then, processor 722 may perform different operations. For instance, processor 722 may receive no response control frame. Alternatively, processor 722 may receive, via transceiver 726, a response control frame (e.g., a CTS frame from apparatus 710) in at least one subchannel within the channel width of the control frame.

In some implementations, a Disabled Subchannel Bitmap field in an EHT Operation element for a BSS with which apparatus 720 is associated may indicate punctured subchannels.

In some implementations, the control frame may indicate static bandwidth negotiation with a DYN_BANDWIDTH_IN_NON_HT field set to indicate Static. In some implementations, in receiving no response control frame, processor 722 may receive no response control frame responsive to at least one of the one or more non-punctured non-primary subchannels being CCA busy. In some implementations, in receiving the response control frame, processor 722 may receive the CTS frame in the one or more non-punctured non-primary subchannels within the channel width of the received control frame responsive to each of the one or more non-punctured subchannels being CCA idle.

In some implementations, the control frame may indicate static bandwidth negotiation with a DYN_BANDWIDTH_IN_NON_HT field set to indicate Dynamic. In some implementations, in receiving the response control frame, processor 722 may receive the response control frame with a second channel width for which all the one or more non-punctured non-primary subchannels are within the second channel width responsive to each of the one or more non-punctured non-primary subchannels being CCA idle. In such cases, the second channel width may be less than or equal to the channel width of the received control frame. Alternatively, or additionally, in receiving the response control frame, processor 722 may receive the response control frame in one or more non-punctured non-primary subchannels in a first channel but not a second channel of the two or more channels responsive to each of the one or more non-punctured non-primary subchannels in the first channel being determined to be CCA idle and at least one subchannel in the second channel being CCA busy.

In some implementations, the operation bandwidth may be 320 MHz, and the two or more channels may include a primary 160 MHz channel and a secondary 160 MHz channel. Each of the primary 160 MHz channel and the secondary 160 MHz channel may respectively include eight 20 MHz subchannels. Illustrative Processes

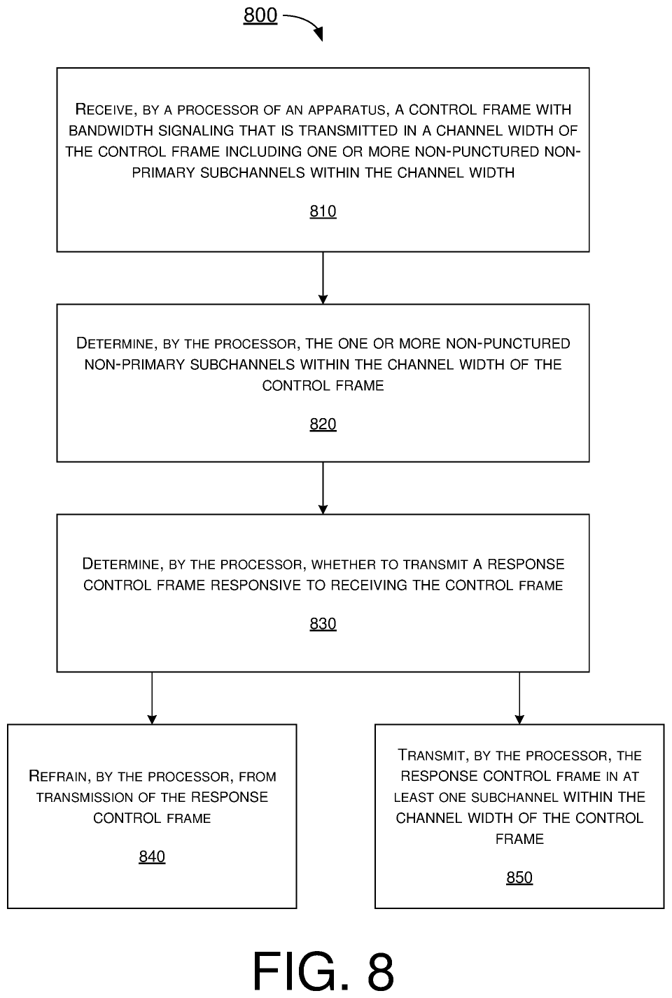

FIG. 8 illustrates an example process 800 in accordance with an implementation of the present disclosure. Process 800 may represent an aspect of implementing various proposed designs, concepts, schemes, systems and methods described above. More specifically, process 800 may represent an aspect of the proposed concepts and schemes pertaining to transmission protection with static puncturing in wireless communications in accordance with the present disclosure. Process 800 may include one or more operations, actions, or functions as illustrated by one or more of blocks 810, 820, 830, 840 and 850. Although illustrated as discrete blocks, various blocks of process 800 may be divided into additional blocks, combined into fewer blocks, or eliminated, depending on the desired implementation. Moreover, the blocks/sub-blocks of process 800 may be executed in the order shown in FIG. 8 or, alternatively in a different order. Furthermore, one or more of the blocks/sub-blocks of process 800 may be executed repeatedly or iteratively. Process 800 may be implemented by or in apparatus 710 and apparatus 720 as well as any variations thereof. Solely for illustrative purposes and without limiting the scope, process 800 is described below in the context of apparatus 710 implemented in or as STA 110 functioning as a non-AP STA and apparatus 720 implemented in or as STA 120 functioning as an AP STA of a wireless network such as a WLAN in network environment 100 in accordance with one or more of IEEE 802.11 standards. Process 800 may begin at block 810.

At 810, process 800 may involve processor 712 of apparatus 710 receiving, via transceiver 716, a control frame (e.g., RTS frame) with bandwidth signaling that is transmitted in a channel width of the control frame including one or more non-punctured non-primary subchannels (e.g., non-primary subchannel(s) being punctured) within the channel width. Process 800 may proceed from 810 to 820.

At 820, process 800 may involve processor 712 determining the one or more non-punctured non-primary subchannels within the channel width of the control frame. Process 800 may proceed from 820 to 830.

At 830, process 800 may involve processor 712 determining whether to transmit a response control frame (e.g., CTS frame) responsive to receiving the control frame. Depending on a result of the determining, process 800 may proceed from 820 to 840 or 850.

At 840, process 800 may involve processor 712 refraining from transmission of any response control frame.

At 850, process 800 may involve processor 712 transmitting, via transceiver 716, the any response control frame (e.g., to apparatus 720) in at least one subchannel within the channel width of the control frame.

In some implementations, in determining the one or more non-punctured non-primary subchannels within the channel width of the control frame, process 800 may involve processor 712 determining the one or more non-punctured non-primary subchannels within the channel width of the control frame based on a Disabled Subchannel Bitmap field in an EHT Operation element for a BSS with which apparatus 710 is associated indicating punctured subchannels. In some implementations, in determining whether to transmit the response control frame, process 800 may involve processor 712 performing, via transceiver 716, CCA on the one or more non- punctured non-primary subchannels within the channel width of the received control frame to determine whether each of the one or more non-punctured non-primary subchannels is CCA idle or busy.

In some implementations, the control frame may indicate static bandwidth negotiation with a DYN_BANDWIDTH_IN_NON_HT field set to indicate Static. In some implementations, in refraining from transmission of the response control frame, process 800 may involve processor 712 refraining from transmission of the response control frame responsive to at least one of the one or more non-punctured non-primary subchannels being determined to be CCA busy. In some implementations, in transmitting the response control frame, process 800 may involve processor 712 transmitting the response control frame in the one or more non-punctured non-primary subchannels within the channel width of the received control frame responsive to each of the one or more non-punctured non-primary subchannels being determined to be CCA idle.

In some implementations, the control frame may indicate static bandwidth negotiation with a DYN_BANDWIDTH_IN_NON_HT field set to indicate Dynamic. In some implementations, in transmitting the response control frame, process 800 may involve processor 712 transmitting the response control frame with a second channel width for which all the one or more non-punctured non-primary subchannels are within the second channel width responsive to each of the one or more non-punctured non-primary subchannels being determined to be CCA idle. In such cases, the second channel width may be less than or equal to the channel width of the received control frame. Alternatively, or additionally, in transmitting the response control frame, process 800 may involve processor 712 transmitting the response control frame in one or more non-punctured non-primary subchannels in a first channel but not a second channel of the two or more channels responsive to each of the one or more non-punctured non-primary subchannels in the first channel being determined to be CCA idle and at least one subchannel in the second channel being determined to be CCA busy.

In some implementations, the operation bandwidth may be 320 MHz, and the two or more channels may include a primary 160 MHz channel and a secondary 160 MHz channel. Each of the primary 160 MHz channel and the secondary 160 MHz channel may respectively include eight 20 MHz subchannels.

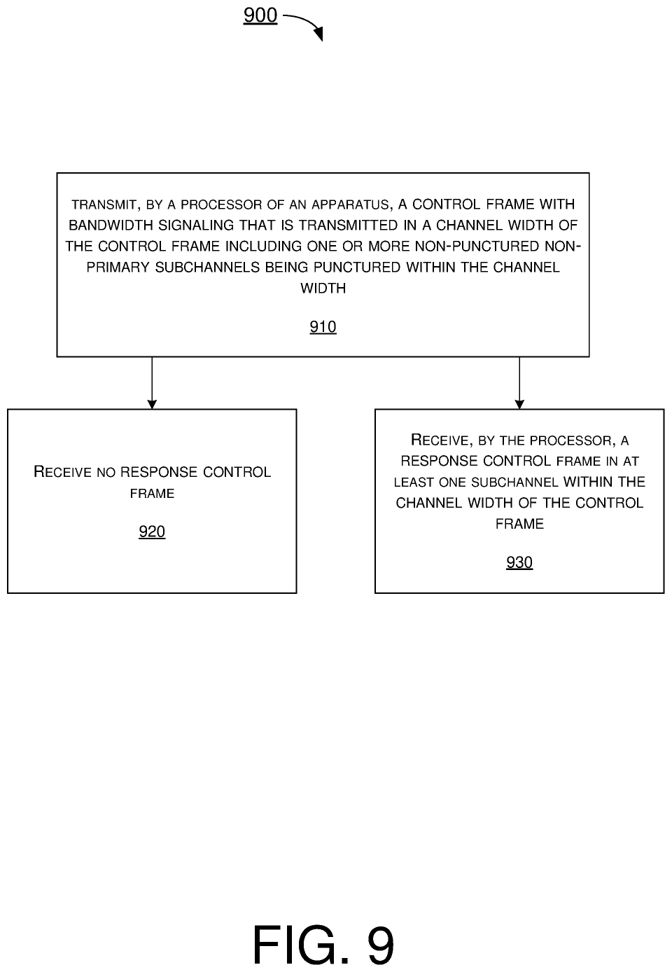

FIG. 9 illustrates an example process 900 in accordance with an implementation of the present disclosure. Process 900 may represent an aspect of implementing various proposed designs, concepts, schemes, systems and methods described above. More specifically, process 900 may represent an aspect of the proposed concepts and schemes pertaining to transmission protection with static puncturing in wireless communications in accordance with the present disclosure. Process 900 may include one or more operations, actions, or functions as illustrated by one or more of blocks 910, 920 and 930. Although illustrated as discrete blocks, various blocks of process 900 may be divided into additional blocks, combined into fewer blocks, or eliminated, depending on the desired implementation. Moreover, the blocks/sub-blocks of process 900 may be executed in the order shown in FIG. 9 or, alternatively in a different order. Furthermore, one or more of the blocks/sub-blocks of process 900 may be executed repeatedly or iteratively. Process 900 may be implemented by or in apparatus 710 and apparatus 720 as well as any variations thereof. Solely for illustrative purposes and without limiting the scope, process 900 is described below in the context of apparatus 710 implemented in or as STA 110 functioning as a non-AP STA and apparatus 720 implemented in or as STA 120 functioning as an AP STA of a wireless network such as a WLAN in network environment 100 in accordance with one or more of IEEE 802.11 standards. Process 900 may begin at block 910.

At 910, process 900 may involve processor 722 of apparatus 720 transmitting, via transceiver 726, a control frame (e.g., RTS frame) with bandwidth signaling that is transmitted in a channel width of the control frame including one or more non-punctured non-primary subchannels (e.g., non-primary subchannel(s) being punctured) within the channel width. Process 900 may proceed from 910 to 920 or 930.

At 920, process 900 may involve processor 722 receiving no response control frame.

At 930, process 900 may involve processor 722 receiving, via transceiver 726, a response control frame (e.g., from apparatus 710) in at least one subchannel within the channel width of the control frame.

In some implementations, a Disabled Subchannel Bitmap field in an EHT Operation element for a BSS with which apparatus 720 is associated may indicate punctured subchannels.

In some implementations, the control frame may indicate static bandwidth negotiation with a DYN_BANDWIDTH_IN_NON_HT field set to indicate Static. In some implementations, in receiving no response control frame, process 900 may involve processor 722 receiving no response control frame responsive to at least one of the one or more non-punctured non-primary subchannels being CCA busy. In some implementations, in receiving the response control frame, process 900 may involve processor 722 receiving the response control frame in the one or more non-punctured non-primary subchannels within the channel width of the received control frame responsive to each of the one or more non-punctured subchannels being CCA idle.

In some implementations, the control frame may indicate static bandwidth negotiation with a DYN_BANDWIDTH_IN_NON_HT field set to indicate Dynamic. In some implementations, in receiving the response control frame, process 900 may involve processor 722 receiving the response control frame with a second channel width for which all the one or more non-punctured non-primary subchannels are within the second channel width responsive to each of the one or more non-punctured non-primary subchannels being CCA idle. In such cases, the second channel width may be less than or equal to the channel width of the received control frame. Alternatively, or additionally, in receiving the response control frame, process 900 may involve processor 722 receiving the response control frame in one or more non-punctured non-primary subchannels in a first channel but not a second channel of the two or more channels responsive to each of the one or more non-punctured non-primary subchannels in the first channel being determined to be CCA idle and at least one subchannel in the second channel being CCA busy.

In some implementations, the operation bandwidth may be 320 MHz, and the two or more channels may include a primary 160 MHz channel and a secondary 160 MHz channel. Each of the primary 160 MHz channel and the secondary 160 MHz channel may respectively include eight 20 MHz subchannels.

Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a control frame with bandwidth signaling that is transmitted in a channel width of the control frame including one or more non-punctured non-primary subchannels within the channel width;
determining, by the processor, the one or more non-punctured non-primary subchannels within the channel width of the control frame;
determining, by the processor, whether to transmit a response control frame responsive to receiving the control frame; and
depending on a result of the determining, either:
refraining, by the processor, from transmission of the response control frame; or
transmitting, by the processor, the response control frame in at least one subchannel within the channel width of the control frame.

2. The method of claim 1, wherein the determining of the one or more non-punctured non-primary subchannels within the channel width of the control frame comprises determining based on a Disabled Subchannel Bitmap field in an Extremely-High-Throughput (EHT) Operation element for a basic service set (BSS) with which the apparatus is associated indicating punctured subchannels.

3. The method of claim 2, wherein the determining whether to transmit the response control frame comprises performing a clear channel assessment (CCA) on the one or more non-punctured non-primary subchannels within the channel width of the received control frame to determine whether each of the one or more non-punctured non-primary subchannels is CCA idle or busy.

4. The method of claim 3, wherein the control frame indicates static bandwidth negotiation with a DYN_BANDWIDTH_IN_NON_HT field set to indicate Static.

5. The method of claim 4, wherein the refraining from transmission of the response control frame comprises refraining from transmission of the response control frame responsive to at least one of the one or more non-punctured non-primary subchannels being determined to be CCA busy.

6. The method of claim 4, wherein the transmitting of the response control frame comprises transmitting the response control frame in all the one or more non-punctured non-primary subchannels within the channel width of the received control frame responsive to each of the one or more non-punctured non-primary subchannels being determined to be CCA idle.

7. The method of claim 3, wherein the control frame indicates static bandwidth negotiation with a DYN_BANDWIDTH_IN_NON_HT field set to indicate Dynamic.

8. The method of claim 7, wherein the transmitting of the response control frame comprises transmitting the response control frame with a second channel width for which all the one or more non-punctured non-primary subchannels are within the second channel width responsive to each of the one or more non-punctured non-primary subchannels being determined to be CCA idle, and wherein the second channel width is less than or equal to the channel width of the received control frame.

9. An apparatus, comprising:
a transceiver configured to communicate wirelessly; and
a processor coupled to the transceiver and configured to perform, via the transceiver, operations comprising:
receiving, via the transceiver, a control frame with bandwidth signaling that is transmitted in a channel width of the control frame including one or more non-punctured non-primary subchannels within the channel width;
determining the one or more non-punctured non-primary subchannels within the channel width of the control frame;
determining whether to transmit a response control frame responsive to receiving the control frame; and
depending on a result of the determining, either:
refraining from transmission of the response control frame; or
transmitting, via the transceiver, the response control frame in at
least one subchannel within the channel width of the control frame.

10. The apparatus of claim 9, wherein the determining of the one or more non-punctured non-primary subchannels within the channel width of the control frame comprises determining based on a Disabled Subchannel Bitmap field in an Extremely-High-Throughput (EHT) Operation element for a basic service set (BSS) with which the apparatus is associated indicating punctured subchannels.

11. The apparatus of claim 10, wherein the determining whether to transmit the response control frame comprises performing a clear channel assessment (CCA) on the one or more non-punctured non-primary subchannels within the channel width of the received control frame to determine whether each of the one or more non-punctured non-primary subchannels is CCA idle or busy.

12. The apparatus of claim 11, wherein the control frame indicates static bandwidth negotiation with a DYN_BANDWIDTH_IN_NON_HT field set to indicate Static.

13. The apparatus of claim 12, wherein the refraining from transmission of the response control frame comprises refraining from transmission of the response control frame responsive to at least one of the one or more non-punctured non-primary subchannels being determined to be CCA busy.

14. The apparatus of claim 12, wherein the transmitting of the response control frame comprises transmitting the response control frame in all the one or more non-punctured non-primary subchannels within the channel width of the received control frame responsive to each of the one or more non-punctured non-primary subchannels being determined to be CCA idle.

15. The apparatus of claim 11, wherein the control frame indicates static bandwidth negotiation with a DYN_BANDWIDTH_IN_NON_HT field set to indicate Dynamic.

16. The apparatus of claim 15, wherein the transmitting of the response control frame comprises transmitting the response control frame with a second channel width for which all the one or more non-punctured non-primary subchannels are within the second channel width responsive to each of the one or more non-punctured non-primary subchannels being determined to be CCA idle, and wherein the second channel width is less than or equal to the channel width of the received control frame.
